(19) United States
(12) Patent Application Publication
(10) Pub. No.: US 2023/0042109 A1
(43) Pub. Date: Feb. 9, 2023

(54) AUTOMATIC DISPENSER OF FLUID PRODUCTS CONTAINED IN CARTRIDGES HAVING A SECURE SHELL AND A METERING PUMP CONTAINER

(71) Applicant: LINKEDTECH, PARIS (FR)

(72) Inventor: Christophe HORVATH, Bons-et-chablais (FR)

(21) Appl. No.: 17/784,308

(22) PCT Filed: Dec. 16, 2020
(86) PCT No.: PCT/EP2020/086582

§ 371 Date: Jun. 10, 2022

(30) Foreign Application Priority Data
Dec. 17, 2019 (FR) 1914673

(51) Int. Cl. B05B 11/00; G06K 19/07

(52) U.S. Cl. CPC B05B 11/3081; B05B 11/0038; B05B 11/0054; B05B 11/0027; B05B 11/0078; G06K 19/0723; B05B 11/3011

(57) ABSTRACT

The invention relates to a secure shell for a container (200) with a metering pump for dispensing fluid, enabling secure metering and traceable dispensing. The shell (100) is rigid and includes a first outlet port (111) intended to face the ejector port (211) of the pump (210) and at least one actuator port (101) intended in use to receive an actuator rod (400-401) supported by an automatic dispenser in order to actuate the mechanical pump, the actuator port having a section that is smaller than the section of a three-year-old child's finger.

The invention relates to a secure shell for a reservoir with a metering pump for dispensing fluid enabling secure metering and traceable dispensing. The invention also relates to a cartridge including this type of shell and a fluid product reservoir provided with a mechanical pump, as well as an automatic dispenser using this kind of cartridge.

The health and cosmetics industries are increasingly tending to favor the personalisation of products as a function of the end user. This tendency is observed for example in the preparation of pharmaceutical treatments specifically matched to the patient as a function of their sex, their age, their genetic inheritance and specific features of their disease, such as their cancer or the strain of a virus.

This kind of preoccupation also relates to the field of food supplements for optimising the efficacy of the supplements whilst limiting negative effects and/or overdoses and matching in real time the composition of the solution to the actual needs of the patient or of the consumer.

In order to enable this kind of personalised preparation there have already been proposed automatic dispensers including at least two cartridges with different components and a pneumatic or mechanical pumping mechanism (of syringe plunger type).

The patent document FR3044219 describes an automatic device including a control interface controlling syringe plungers provoking the injection of the content of the syringes into flexible tubes that join in a mixing zone consisting of a connector with multiple inlets connected to a cone for ejection of the cosmetic composition prepared in this way.

However, the use of syringe plungers renders the machine very costly, relatively imprecise in terms of volume dispensed, somewhat impractical for changing the reservoirs of products, and very bulky, because a lot of room is required to enable the pistons to be pulled back. Moreover, if the machine were modified to facilitate changing the cartridges it would be easy to access the product remaining in the cartridges, which could be hazardous, in particular for children and in particular for babies.

The document WO2014080093 describes an automatic device including a support for single-use cartridges containing the active ingredients, a block for mixing the active ingredients, a hollow needle adapted to pierce the cartridges, and means for aspirating the active ingredients through said hollow needle toward the mixing block.

The use of unique capsules obliges the user to perform numerous manipulations and introduces a risk of error. This generates numerous costs (financial and ecological) and the fact of not being able to change the quantity administered per capsule limits the possible number of formulations.

Moreover, when changing cartridges it is very easy to access the remaining product, simply by letting it flow through the hole pierced by the needle, without having to damage the cartridge.

It is therefore not possible at present to propose a system for secure, that is to say reliable and tamper-proof, dispensing of a fluid product whilst being practical in terms of changing cartridges.

By secure is meant that the invention prevents the manual dispensing of product outside of the dispensing system.

By fluid product is meant any liquid, viscous or paste-like product that can be dispensed by a metering pump from a reservoir to a product outlet.

By tamper-proof is meant that any sampling of product outside the machine necessitates irreversible and intentional damage to the cartridge that cannot be camouflaged or repaired.

Moreover, it would also be desirable to be able to offer cartridges of standard size whilst rendering use easy for the consumer.

Now, to be sure that the dispenser actuates the correct cartridge it is either necessary to indicate to it the place of the cartridge in the various locations or to dedicate a location to only one type of cartridge.

This latter solution has been chosen in the document U.S. Pat. No. 10,022,741 which describes a device of this kind in which each cartridge has a different shape in order to be inserted in a single and unique position. Also, from the commercial point of view, these cartridges are sold in the form of a single combination that must be changed in its entirety.

For obvious reasons of overall size, the machine can offer only a limited number of cartridges, which limits the combination of products and is undesirable. Alternatively, it would be necessary to provide for each product from the catalogue as many shapes of cartridges as of locations to enable a large number of combinations of products, but the location information would be lost, which is not desirable either and would necessitate manual input of information into the machine.

The prior solutions do not prevent recovery of the product by simple manual opening. Nor do they offer reliable tracking of the quantity dispensed over time, even if the cartridges are transferred from one dispenser to another.

Moreover they propose cartridges with different and non-standard shapes. Now, the use of cartridges of the same standard shape would make it possible, with a limited number of locations, to provide a very comprehensive catalogue of products, provided that the machine is able to tell which product is in which location in order to be able to dispense the required mixture, in the required dose, with no possibility of bypassing or delivery from the machine without this being seen.

An objective of the invention is therefore to enable dispensing of a liquid content with accurate metering by mechanical action of a dispenser on the cartridge, whilst excluding the possibility of using the product contained in the cartridge without the aid of the dispenser, that is to say by preventing recovery of the content by non-destructive manual action.

The invention also aims to enable automatic and secure verification of the cartridge, that is to say without intervention of the user and therefore with no risk of human error, to ensure the correct use of the cartridge, as well as its traceability, metering and limiting the use of the cartridge to a predefined quantity dispensed to prevent overuse, even unintentionally, of a potentially hazardous product.

One objective of the present invention is to propose a cartridge enabling precise, traceable and protected dispensing of a fluid solution by an automatic dispenser.

In particular, the invention aims to enable precise, traceable and protected dispensing of fluid solution thanks to the automatic actuation of the metering pump of a reservoir by an automatic dispenser.

Another objective is to propose a cartridge of low cost enabling use of an equally low cost automatic dispenser.

One of the ideas behind the invention is to use reservoirs of products including a mechanical pump of metering pump type but modified to be able to be actuated by the automatic dispenser whilst preventing manual actuation of the pump.

This type of manually-actuated metering pump is described for example in the patents EP1572375 and EP2841206. The accuracy of the metering is guaranteed by the metering pump, which dispenses a fixed volume when mechanically activated, typically by linear pushing in an axial direction of the pump. The volume delivered depends on the metering pump and it is therefore possible to equip a reservoir of standard shape with metering pumps ejecting different volumes.

In particular, the invention proposes a simple solution of low cost enabling use of commercial reservoirs such as those described in the patents EP1412263 and EP2841206 and that enable sterile dispensing of a product.

The invention proposes to use a standard reservoir whatever the product, provided with a metering pump, and to add a particular rigid shell that completely covers the reservoir provided with the metering pump and that is designed to enable automatic activation and to prevent manual activation of the metering pump, and that can incorporate other functions, in particular of making the delivery of the product secure.

By convention, in the remainder of the present description a cartridge in accordance with the invention therefore includes a rigid shell containing a reservoir of fluid provided with a mechanical metering pump enabling dispensing of a known dose by mechanical action on the reservoir.

The reservoir may be simple or consist of a rigid part containing a flexible sachet containing the product.

The cartridges serve to contain a product (solution) in fluid form and are actuated mechanically by an automatic dispenser to dispense the content thereof.

To be more precise, the invention has for object an automatic dispenser of fluid products contained in cartridges, the dispenser including at least two fluid product cartridges each including a fluid product reservoir provided with a mechanical pump that can be actuated in an axial direction and has a port for ejection of product in a particular direction, and a rigid protection shell including a first outlet port intended to be connected with the ejector port of the pump, and at least one actuator port, the automatic dispenser further including at least two actuator rods that can be driven selectively in an axial direction of activation of the mechanical pump of the cartridges, each actuator rod being intended to be inserted in the actuator port of a cartridge to actuate the mechanical pump, the actuator ports and the actuator rods having a section less than 9 millimetres, advantageously less than 6 millimetres, typically between 3 and 6 millimetres

In accordance with particular embodiments:

each actuator may be mounted to be mobile in pivoting and intended to be inserted in the actuator port of the shell and to be engaged in a yoke carried by the reservoir of each cartridge to push the mechanical pump of the cartridge through the actuator port;

each actuator rod may be mounted to be mobile in translation parallel to the axial direction of actuation of the pump of the cartridges, each actuator rod being intended to be inserted in an actuator port of a cartridge, the port being arranged in the axial direction relative to the pump;

the cartridges may further include an electronic chip adapted to be read and/or written, the automatic dispenser including a system for reading/writing the electronic chip of each cartridge;

the automatic dispenser may include a connection to a remote database storing information via a communication network, in which the chip stores at least one serial number of the cartridge, the dispenser being programmed to read the serial number in each chip, to be connected to the remote database to consult the stored information corresponding to the serial number of each cartridge, to adapt the actuation of the corresponding cartridge as a function of that information and to modify that information in the remote database to take into account actuation of the cartridge;

the chip may store information relating to the product contained in the cartridge, the dispenser being programmed to read the information stored in each chip, and to enable actuation of the corresponding cartridge if the product contained in the cartridge must be dispensed and to block actuation of the corresponding cartridge if the product contained in the cartridge must not be dispensed;

the chip stores cartridge usage history information, the dispenser being programmed to read the usage history information stored in each chip, to adapt the actuation of the corresponding cartridge as a function of that information and to modify the cartridge usage history in each chip to take into account actuation of the cartridge;

the chip may additionally store information as to the maximum quantity of the product that can be consumed per unit period, the dispenser being programmed to read the information stored in each chip, to consult the usage history information, to enable actuation of the corresponding cartridge if the maximum quantity of the product consumable per unit period is not exceeded and to block actuation of the corresponding cartridge if the maximum quantity of the product consumable per unit period is exceeded;

the chip may store information as to the use by date of the cartridge, the dispenser being programmed to read the use by date information stored in each chip, to enable actuation of the corresponding cartridge if the use by date of the cartridge is not exceeded, and to block actuation of the corresponding cartridge if the use by date of the cartridge is exceeded;

the chip may store information as to the remaining quantity of product in the cartridge, the dispenser being programmed to read the remaining quantity of product in the cartridge information stored in each chip, to alert the user if the remaining quantity of production in a cartridge is less than a predetermined quantity threshold and/or

the cartridges may include a shell provided with a passive access lock mobile between a position blocking access to the actuator ports and a position unblocking access to said at least one actuator port, the lock including:

at least one fin for blocking said at least one actuator port,

at least one leaf spring intended to be deformed elastically against at least one stop carried by an interior surface of the shell,

a drive sleeve intended to receive an unlocking member to move said at least one blocking fin from the locking position toward the unlocking position, said at least one leaf spring being arranged relative to said at least one blocking fin so that in the unlocking position the or each leaf spring is deformed elastically against the or each stop and said at least one blocking fin does not block said at least one activator port, and that in the locking position said at least one leaf spring is not deformed elastically against said at least one stop and said at least one blocking fin blocks said at least one activator port, the dispenser including an unlocking member adapted to cooperate with the drive sleeve of the passive access lock of each cartridge, the dispenser being programmed so that the unlocking member can reversibly move the passive access lock of each cartridge from a locking position toward an unlocking position.

The invention also has for object a protection shell for a reservoir of fluid product provided with a mechanical pump that can be activated in an axial direction and has a port for ejection of product in a particular direction, in which the shell is rigid and includes a first outlet port intended to be connected with the ejector port of the pump and at least one actuator port adapted, in use, to cooperate with an actuator rod carried by the aforementioned automatic dispenser to actuate the mechanical pump, the actuator port having a section less than 9 millimetres, advantageously less than 6 millimetres, typically between 3 and 6 millimetres.

This shell therefore enables dispensing by the automatic dispenser whilst preventing manual access to the metering pump in order to prevent manual dispensing of the product.

In accordance with particular embodiments:

the shell may further include a housing for an electronic chip adapted to be read and/or written by a corresponding electronic system of an automatic dispenser;

the housing may be arranged in the shell under a face of the shell perpendicular to the axial longitudinal direction;

the housing may be arranged in a centred manner relative to a median longitudinal axis of the shell;

the shell may further include a passive access lock mobile between a position blocking access to the actuator ports and a position unblocking access to said at least one actuator port, the lock including:

at least one fin for blocking said at least one actuator port,

at least one leaf spring intended to be deformed elastically against at least one stop carried by an interior surface of the shell,

a drive sleeve intended to receive an unlocking member to move said at least one blocking fin from the locking position toward the unlocking position, said at least one leaf spring being arranged relative to said at least one blocking fin so that in the unlocking position the or each leaf spring is deformed elastically against the or each stop and said at least one blocking fin does not block said at least one activator port, and that in the locking position said at least one leaf spring is not deformed elastically against said at least one stop and said at least one blocking fin blocks said at least one activator port;

the outlet port may be provided with a tube connecting it to the ejector port of the pump in the position of use;

the connecting tube may have a shape such that in use the product is ejected via the outlet port in a direction different from the ejection direction of the ejector port of the pump;

the actuator port may be a hole with a section less than 9 millimetres, advantageously less than 6 millimetres, typically between 3 and 6 millimetres;

the actuator port may be in the form a slot with a width less than 9 millimetres, advantageously less than 6 millimetres, typically between 3 and 6 millimetres;

the shell may include a first or housing part intended to receive a reservoir of fluid product provided with a mechanical pump that can be activated in an axial direction and a second or closing part intended to be fixed to the first or housing part when the reservoir is inserted therein;

the shell may include a stop assembly for inactivation of the pump; and/or

the stop assembly for inactivation of the pump may include a plane base provided with at least one rigid locking rod intended to bear against the reservoir in the locking position, the plane base further including a clipping portion intended to be inserted in a port of the shell, the shell including on its front face facing the pump and perpendicular to the longitudinal axis at least one port intended to receive said at least one locking rod and on a lateral face parallel to the longitudinal axis a port for immobilising the clipping portion.

The invention also has for object a fluid product cartridge for the aforementioned automatic dispenser, the cartridge including the aforementioned shell and a reservoir of fluid product provided with a mechanical pump that can be activated in an axial direction.

In accordance with particular embodiments:

the cartridge may further include an electronic chip adapted to be read and/or written by a corresponding electronic system of the automatic dispenser;

the reservoir may be provided with at least one yoke intended in use to receive an actuator rod driven by an automatic dispenser, the yoke being adapted to enable activation of the mechanical pump of the reservoir when the actuator rod is inserted in an actuator port of the shell and to move the yoke in the axial direction of actuation of the pump;

the actuator port may be in the form of a slot with a width less than the finger section of a three-year-old child and enables actuation of the pump by pivoting of the actuator rod in us; and/or

the actuator port of the rigid shell may be arranged in the axial direction of actuation of the pump and intended in use to receive an actuator rod driven in translation by the automatic dispenser to enable actuation of the pump by a movement in translation of the actuator rod parallel to the axial direction of actuation of the pump.

Other features of the invention will be set out in the following detailed description with reference to the appended figures, provided by way of example, which respectively represent:

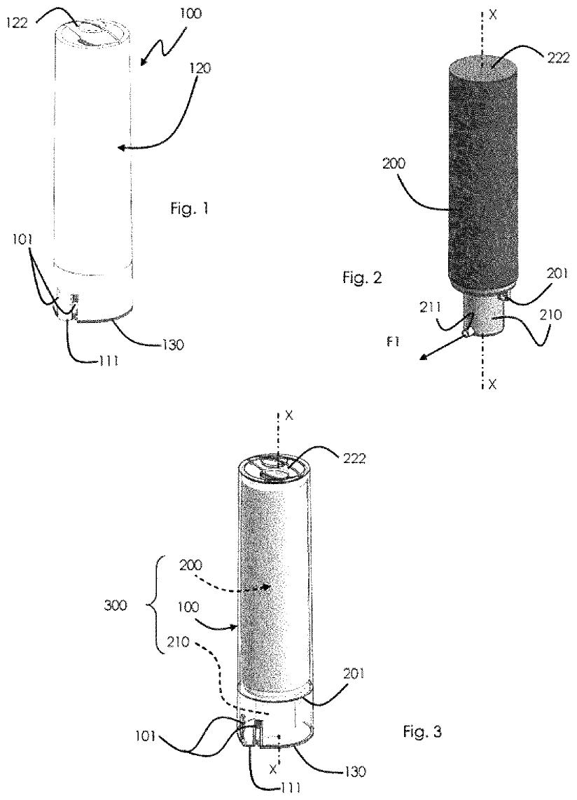

FIG. 1 a schematic perspective view of a first embodiment of a cartridge shell in accordance with the invention, in which the actuator port is in the form of a slot to enable actuation of the metering pump by pivoting of two activator rods;

FIG. 2 a schematic perspective view of a first embodiment of a reservoir intended to be inserted in the shell from FIG. 1;

FIG. 3 a schematic perspective view of the cartridge obtained by assembling the shell from FIG. 1 and the reservoir from FIG. 2 seen inside the shell as if transparent;

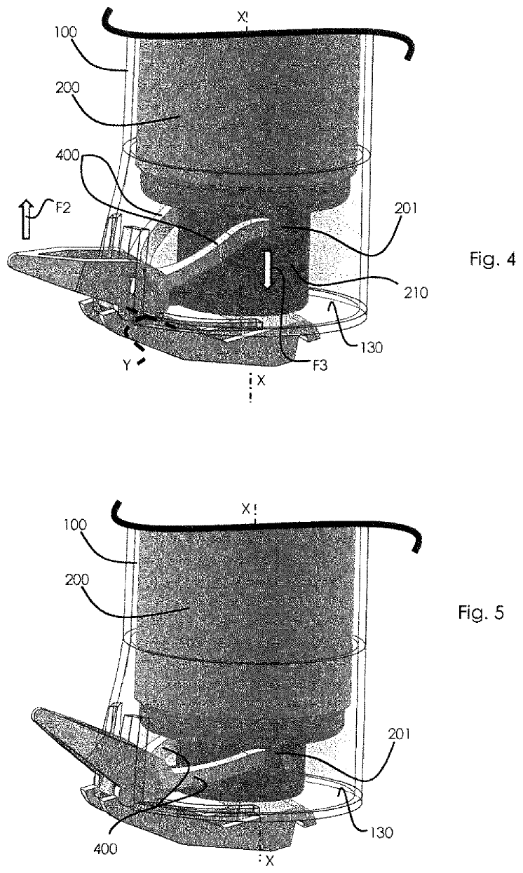

FIG. 4 a schematic partial perspective view of the first cartridge embodiment from FIG. 3 engaged with two actuator rods of an automatic dispenser in accordance with the invention before actuation of the metering pump;

FIG. 5 a schematic partial perspective view of the first cartridge embodiment from FIG. 3 engaged with two actuator rods of an automatic dispenser in accordance with the invention after actuation of the metering pump;

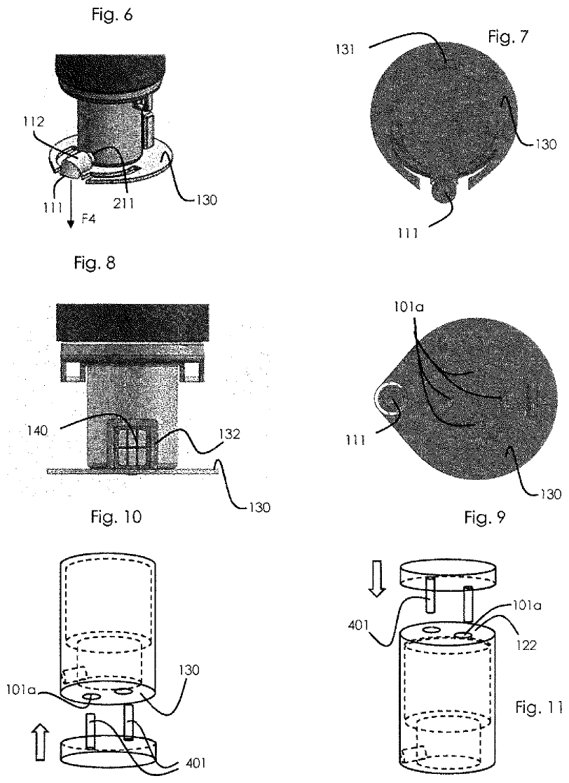

FIG. 6 a schematic perspective view of an advantageous embodiment of a closing part of the shell including the outlet port of the shell provided with a tube connecting it to the ejector port of the metering pump;

FIG. 7 a schematic view as seen from below of the closing part from FIG. 4;

FIG. 8 a schematic side view of a closing part including a housing for an electronic chip;

FIG. 9 a schematic view from below of a second embodiment of a cartridge shell in accordance with the invention including a closing part provided with actuator holes arranged in the axial actuation direction relative to the metering pump;

FIG. 10 a schematic perspective view of direct activation of the metering pump of the embodiment from FIG. 9 from the top of the pump;

FIG. 11 a schematic perspective view of a variant activation of the metering pump from the bottom of the reservoir;

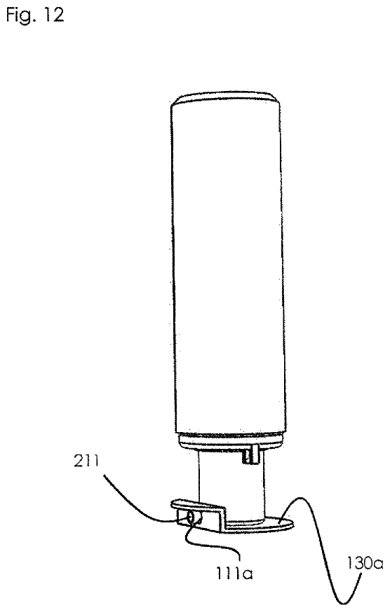

FIG. 12 a schematic perspective view of an alternative embodiment of a closing part of the shell including an outlet port that can be connected directly to the ejector port of the metering pump;

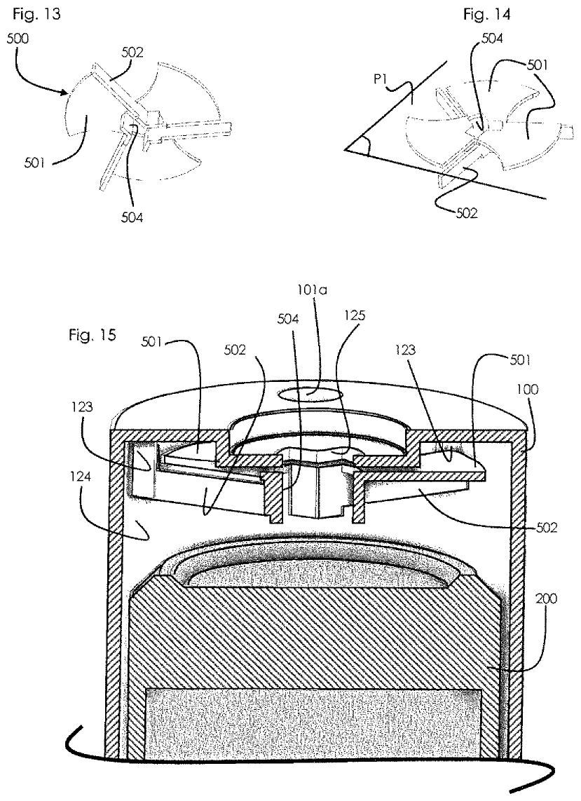

FIG. 13 a schematic low angle perspective view of an embodiment of a lock for blocking access to the actuator holes of a shell in accordance with the invention;

FIG. 14 a schematic high angle perspective view of the access lock from FIG. 13;

FIG. 15 a schematic part-sectional view of a cartridge provided with a shell in accordance with the invention equipped with the access lock from FIGS. 13 and 14;

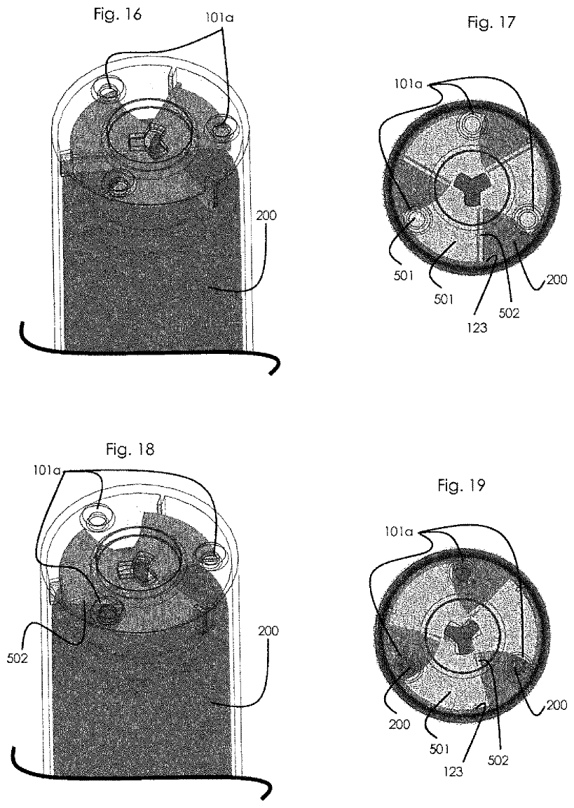

FIG. 16 a schematic perspective view of the cartridge from FIG. 15 the shell of which is illustrated as if transparent and the lock of which is in the locked position blocking the activator holes;

FIG. 17 a schematic perspective view as seen from above of the cartridge from FIG. 16;

FIG. 18 a schematic perspective view of the cartridge from FIG. 15 the shell of which is illustrated as if transparent and the lock of which is in the unlocked position opening the actuator holes;

FIG. 19 a schematic perspective view as seen from above of the cartridge from FIG. 18;

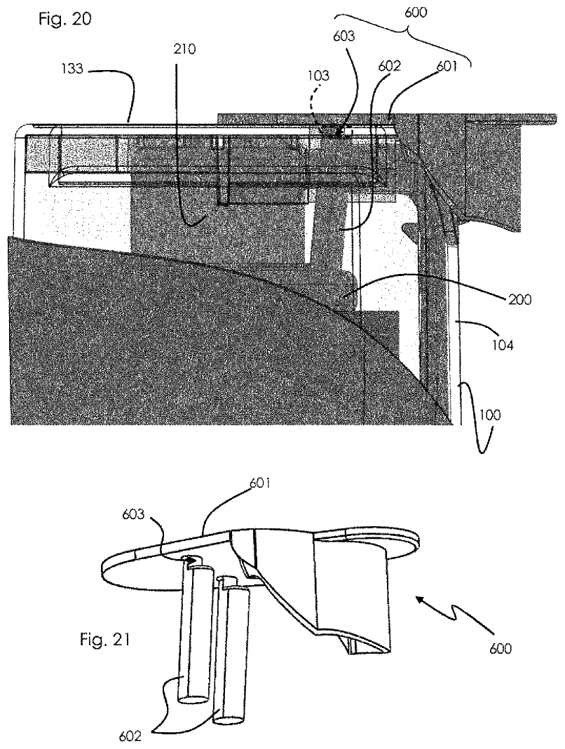

FIG. 20 a schematic part-sectional view of a cartridge provided with a stop assembly to prevent accidental inactivation of the pump; and

FIG. 21 a schematic perspective view of the inactivation stop assembly from FIG. 20.

FIG. 1 illustrates a first embodiment of a tamper-proof protection shell 100 of a cartridge in accordance with the invention.

The shell 100 is intended to cover entirely a reservoir 200 of fluid product (see FIG. 2) provided with a mechanical metering pump 210 that can be activated in an axial direction X-X.

The metering pump 210 is provided with a port 211 for ejecting product in a particular direction F1.

In accordance with the invention, the shell 100 is rigid and includes an outlet port 111 intended to face the ejector port 211 of the pump 210.

In accordance with the invention, one of the surfaces of the shell includes one or more actuator ports enabling an automatic dispenser to access the mechanism for activation of the pumps to perform the dispensing. These ports are of significantly smaller size than a finger of a child old enough to actuate the metering pump (that is to say capable of applying a force of approximately 30 Newtons), typically a child of at least three years of age, and a fortiori an adult, in order to prevent accidental use of the cartridges outside the automatic dispenser.

Thus in the embodiment illustrated the shell 100 includes two actuator ports 101 intended in use to receive an actuator rod carried by an automatic dispenser for mechanical actuation of the metering pump.

In this embodiment, the actuator ports 101 are in the form of a slot to enable actuation of the metering pump by pivoting of two activator rods (see FIGS. 4 and 5). In the present description a slot is an oblong, that is to say narrow and long port. In other words, its length is very much greater than its width and its depth (which corresponds to the thickness of the shell). What is important in accordance with the invention is that the width of the slot is less than the diameter of a finger of a three-year-old child. In contrast, a hole is defined in the present description as an opening the width and the length of which are of the same order of magnitude, that is to say its length is less than twice its width. A hole may have a circular or polygonal section. What is important in accordance with the invention is that the section of the hole is less than the section of a finger of a three-year-old child.

In accordance with the invention, the actuator ports have a section (here the width) less than a section of a finger of a three-year-old child, which prevents them from being able to access with their fingers the mechanism of the metering pump of the reservoir and to trigger manually the deliverance of the product contained in the reservoir.

Of course, the person skilled in the art is easily able to assess the size of the fingers of a three-year-old child, which is a reference used in very many international safety standards, for example in systems for preventing trapping of fingers in electric car windows (see for example Hohendorff et al., Annals of Anatomy 192 (2010) 156-161). That study shows that the average diameter of the finger of a three-year-old child is greater than 9 millimetres for the smallest phalanx of the little finger and can be as much as 15 millimetres for the index finger and the middle finger.

By way of illustrative and non-limiting example, a width of the slot 101 (or the diameter of a cylindrical port for the other embodiments described hereinafter) in accordance with the invention is between 3 and 6 millimetres inclusive, typically of the order of 4 millimetres.

The shell is made of an undeformable solid material and covers entirely the reservoir provided with the metering pump.

The tamper-proof character of the shell therefore applies to the actuator port and resides in the fact that to actuate the pump with the fingers it is necessary to enlarge the hole, which constitutes irreversible and visible damage to the shell.

In a particular embodiment illustrated in FIGS. 13 to 19 the shell includes a safety lock blocking the ports when the cartridge is outside the dispenser, thus preventing the insertion of rods of smaller diameter than the section of the actuator ports.

The shell 100 advantageously includes a tubular housing first part 120 intended to receive the reservoir of fluid product and its pump and a closing second part 130 intended to be fixed onto the housing first part when the reservoir is inserted therein. This fixing is preferably irreversible to prevent any invisible demounting of the cartridge. For example, fixing may be effected by means of glue or of spring lugs that have a break line in the event of a force greater than a threshold tear-off force.

Alternatively or additionally the seal plane between the two parts of the shell may be covered by a sticky tell-tale strip that can be torn, rendering any demounting visible.

Alternatively, in such a manner as to enable demounting and recycling of the various parts of the cartridge the two parts can be demounted only using specialist tools that are not commercially available.

FIG. 2 illustrates a reservoir 200 suitable for the shell embodiment from FIG. 1.

This reservoir 200 includes two yokes 201 each intended to receive an actuator rod driven by an automatic dispenser.

Each yoke is adapted to enable activation of the mechanical pump 210 of the reservoir when the corresponding actuator rod is inserted in an actuator port 101 of the shell 100 and moves the yoke 201 in the axial direction X-X of actuation of the pump.

In the embodiment illustrated the yokes 201 are fastened to the reservoir and in the figure are arranged above the pump. Thus when the pump is resting on an immobile surface lowering the yokes lowers the reservoir relative to the pump and relative to the shell, which actuates the pump and causes a dose of product to exit.

To form the cartridge 300 in accordance with the invention illustrated in FIG. 3 the reservoir 200 is inserted in the housing first part 120 of the shell 100 so that the bottom 222 of the reservoir is against the bottom 122 of the housing first part 120 of the shell and the pump 210 is arranged toward the still open end of the housing first part 120 of the shell 100.

In other words, in the position of use the shell is assembled around the reservoir provided with the metering pump, which is positioned upside down.

The shell advantageously has a shape and dimensions close to those of the cartridge provided with the metering pump. This ensures both sliding of the pump or of the body of the reservoir relative to the shell and constant and correct positioning of the reservoir in the shell, so that the activation rods or levers are always able to activate the metering pump (directly or indirectly, as explained below). In other words, the reservoir cannot tilt in the shell, which would prevent activation of the pump, but is able to slide in the shell, which enables activation of the metering pump.

Alternatively or additionally the shell may include insertion guides and/or stop assemblies for retaining the reservoir provided with the pump.

The stop assemblies enable adaptation of reservoirs having a diameter less than the inside diameter of the shell. The shell in accordance with the invention can thus be adapted to a large number of reservoirs of different sizes, while proposing a machine with housings of standard size.

Alternatively or additionally the shell may advantageously include an inactivation stop assembly 600 arranged at a distance from the pump 210, pressing against the shell 100 and the reservoir 200, so that the pump 210 cannot be actuated accidentally, by the inherent weight of the reservoir, in the event of shaking during transportation. In other words, the inactivation stop assembly 600 maintains a constant space between the pump and the shell.

To be more specific, the inactivation stop assembly embodiment 600 illustrated in FIGS. 20 and 21 includes a plane base 601 provided with at least one, preferably two, rigid locking rods 602 arranged at a distance from the pump 210 and intended in the locking position to bear against the reservoir 200, to the rear of the pump 210.

The plane base includes a means for hard fixing of the shell arranged so that a movement of the reservoir toward the plane base in the event of accidental shaking is prevented by the rods 602 and so that the plane base remains fixed to the shell.

For example, as illustrated in FIGS. 20 and 21, the fixing means is a notch 603 arranged at the base of the rods 602 so that when the latter are inserted in the port 103 the edge of that port is inserted in the notch 603. In other words, the plane base 601 bears on the shell and the reservoir is prevented from rising toward the plane base by the rods, which prevent movement of the reservoir relative to the shell.

Alternatively, the fixing means could be a clipping portion extending the plane base perpendicularly and intended to be inserted in another port of the shell 100.

Additionally, the shell 100 includes on its front face 133 facing the pump 210 and perpendicular to the longitudinal axis X-X ports 103 through which are introduced the blocking rods 602 and on a lateral face 104 of the shell parallel to the longitudinal axis X-X a blocking port 102 of the clipping portion 603.

The inactivation stop assembly 600 therefore prevents accidental ejection of product by the mere weight of the reservoir if the cartridge is shaken. Moreover, it is easily removable by the user, who does not need any tool to withdraw it.

In a preferred embodiment this inactivation stop assembly can be cut and also serves as a safety seal enabling one to be sure of the origin and the integrity of the cartridge.

Alternatively or additionally a lubricating product may be added between the reservoir and the shell to ensure easy and durable sliding of the reservoir and actuation of the metering pump. In a variant embodiment the internal surface of the shell is textured and/or covered with a material having a very low coefficient of friction, such as Teflon®.

By textured is meant that the interior surface 124 of the shell includes reliefs, such as grooves or splines, ensuring its retention in the shell, whilst reducing the area of rubbing between the shell and the reservoir, which reduces the friction and ensures perfect compression of the metering pump.

Alternatively or additionally the shell and the reservoir are made of the same material, which enables equivalent thermal expansion or contraction and limits the risk of the reservoir becoming wedged in the shell in the event of a temperature variation.

Alternatively or additionally a shape of the shell different from the shape of the reservoir may be chosen so that the shell is in contact with the circular cylindrical reservoir only along tangential contact lines, which limits the area of contact whilst preventing axial offsetting of the reservoir provided with the metering pump relative to the shell.

The contact lines may advantageously include lubricant or be covered with a material having a low coefficient of friction, such as Teflon®. Since only the tangential lines of contact are covered in this way, this economises the lubrication product or the material with the low coefficient of friction.

For example, if the reservoir has a circular cylindrical section the shell may have an oval or polygonal (triangular, square, etc.) cylindrical section with inside dimensions just greater than the outside dimensions of the reservoir provided with the metering pump to contact the reservoir tangentially. This ensures retention in the actuation position of the reservoir provided with the metering pump whilst limiting the rubbing of the body of the reservoir against the shell during actuation of the metering pump.

Ensuring good sliding of the reservoir relative to the shell ensures operation of the cartridge in accordance with the invention by guaranteeing the delivery of identical doses, but equally removal of the cartridge in accordance with the invention with a view to reusing or recycling the shell.

The closing second part 130 is then fixed onto the first part 120 so that the ejector port 211 of the reservoir (carried by the pump) faces the outlet port 111 of the shell.

The outlet port 111 of the shell advantageously includes an end-piece for guiding the fluid leaving the pump (see FIG. 6).

FIGS. 4 and 5 illustrate the actuation of the pump by an automatic dispenser of which only the actuator rods 400 are illustrated.

In this embodiment positioning the cartridges in their housings triggers the levers 400 mounted to pivot about the axis Y and intended to be engaged in a yoke 201 carried by the reservoir to press on the mechanical pump of the cartridge via the actuator port.

The levers 400 therefore pass through the actuator slots 101 of the shell and engage in the yokes 201 present on the body of the reservoir 200 (FIG. 4).

To activate the cartridge and to distribute a dose of product the levers 400 are pivoted downwards in the direction of the arrow F3, enabling the pump to be pressed against the lower plate 130 of the shell in the direction of the arrow F3 parallel to the axial direction X-X of actuation of the pump.

The actuator slots 101 have a length such that the actuator levers are able to press the metering pump fully downwards when the levers pivot. The actuator slots 101 have a width less than a section of a finger of a three-year-old child, which prevents them from being able to access with their fingers the mechanism of the metering pump of the reservoir and to trigger manually delivery of the product contained in the reservoir.

In other words, the unique shape of the actuator ports 101 of the shell enables the levers to pass through whilst preventing manual activation of the pump.

FIG. 6 illustrates an advantageous embodiment in which the outlet port 111 of the shell is provided with a tube 112 connecting it to the ejector port 211 of the pump 210, enabling guiding of the fluid leaving the pump.

The shell 100 and in particular in the illustrated variant the closing part 130 therefore contain a tube 112 intended to be connected to the ejector port 211 of the pump when mounting the cartridge. This tube enables easy adaptation of the shell to the reservoir that it contains.

The connecting tube 112 preferably has a shape such that the product is ejected via the outlet port 111 in a direction F4 different from the ejection direction F1 of the ejector port 211 of the pump. This enables the ejection of doses from different cartridges to be directed toward a single common zone.

This connecting tube 112 may potentially be changed in order to be cleaned/decontaminated.

Alternatively, as illustrated in FIG. 12 the closing part 130a may be shaped to include an outlet port 111a that can be connected directly to the ejector port 211 of the pump when mounting the cartridge.

The shell advantageously includes a means of blocking rotation of the reservoir provided with the pump about the axis X-X and in particular a means of blocking rotation of the pump relative to the shell. This blocking means may act on the reservoir or on the pump itself. The means for blocking rotation prevents the pump and the shell from becoming offset angularly, which makes it possible to ensure the alignment of the ejector port 211 of the pump and the outlet port 111 or 111a of the shell.

FIG. 7 illustrates the closing part 130 as seen from below, exposing the outlet port 111.

This figure also illustrates a variant of an embodiment of the shell in accordance with the invention including an electronic chip adapted to be read and/or written by a corresponding electronic system of an automatic dispenser.

In this variant, the closing part 130 includes on its exterior face a slot 131 for insertion of an electronic chip 140 and on its internal face, that is to say the one situated inside the closed shell, a housing 132 for said chip 140 (see FIG. 8).

Alternatively, the electronic chip is directly visible on the bottom or on a part of the exterior surface of the shell.

Alternatively, the electronic chip is placed inside the shell so as not to be easily accessible from the outside. In this case, the closing part 130 has no access slot 131 and the chip is simply positioned in its housing before closing the shell. Limitation of access to the chip enables limitation of malicious access to the information contained in it.

In a preferred embodiment the housing is arranged in the shell, under a face of the shell perpendicular to the axial longitudinal direction X-X, namely the front face 133 of the shell situated near the pump 210 of the reservoir 200, or the bottom face 122 of the shell situated at the opposite end to the pump. The housing is preferably arranged in a centred manner relative to a median longitudinal axis X-X of the shell.

In this way, if a plurality of cartridges are used simultaneously in the automatic dispenser and the chips used are of RFID type, there is no risk of interference between the sensors and the various chips, because the latter are spaced from one another by a distance at least equal to twice the radius of the shells, whatever the angular position of the shells. In other words, the user does not need to pay particular attention to the orientation of the cartridges when they are inserted in the dispenser to prevent the radio chips (of NFC or RFID type) of two adjacent cartridges from being situated face to face, risking interference with the sensors.

The face that carries the housing preferably includes an access window enabling a metal contact of the dispenser to come into contact with the chip when the latter is not a radio chip but a chip with electric contacts. This embodiment is particularly advantageous because it limits energy consumption and enhances the security of the communication between the dispenser and the chip. Moreover, this prevents interference with other devices using radio waves.

The chip 140 enables software tracking of the cartridge. This chip 140 is read by the automatic dispenser when the cartridge is placed inside it, the automatic dispenser including a system for reading/writing the electronic chip of each cartridge.

The electronic chip may be of smartcard type. In this case the housing of each cartridge in the dispenser must enable read/write contact with the chip by a suitable system of the automatic dispenser. It is advantageous if only the contacts are accessible from the outside of the shell, the support plate of the contacts being locked in the housing to prevent withdrawal of the smartcard from outside the shell.

In one particular embodiment the housing of the chip includes a spring to press the chip into the reading position when the read/write system of the dispenser is in contact with the chip.

Alternatively, the electronic chip is a radio chip of the NFC or RFID circuit type, so that it can be read and/or written remotely. In this case the chip does not need to be accessible and can be housed and protected in the shell, limiting all possibility of physical access and therefore intentional or otherwise damage.

In a first variant the chip stores at least one serial number of the cartridge. In this case the automatic dispenser in accordance with the invention includes a connection to a remote information storage database by a communication network and is programmed to read the serial number in each chip, to connect to the remote database to consult the stored information corresponding to the serial number of each cartridge, and then to adapt the actuation of the corresponding cartridge as a function of that information. It may advantageously be programmed to modify the information in the remote database to take into account the actuation or the non-actuation of each cartridge.

In this variant as in those that follow, programming the dispenser includes a dispensing prescription, that is to say the quantity to be dispensed per dose, per unit period and per product. This prescription may be stored locally in a memory of the dispenser, stored remotely in a database that can be consulted via a communication network, or read on a removable medium (smartcard or NFC card type) by the dispenser and possessed by each user.

The unique identification number makes it possible to ensure the traceability of the product, from the supplier up to the end user. The identification number also enables remote consultation of information associated with that serial number in a remote database, in particular prescription, history of use, maximum consumable quantity per unit period of the product information. This data can therefore be adjusted remotely by the prescribing professional, which enables the dispenser in accordance with the invention to dispense doses updated almost in real time and to take into account the progress of the user.

In a second variant, as an alternative to or in combination with the first variant, the chip stores information relating to the product contained in the cartridge. In this case, the dispenser is programmed to read the information stored in each chip and to enable actuation of the corresponding cartridge if the product contained in the cartridge has to be dispensed and to block actuation of the corresponding cartridge if the product contained in the cartridge does not have to be dispensed. Thus the dispenser is programmed to refer to a dispensing prescription and can selectively actuate one or more cartridges as a function of the product that they contain.

The product type information enables the automatic dispenser to identify the product it contains and to be able to adjust its dispensing program without running any risk of human error when programming the machine, in particular in positioning the cartridges in the automatic dispenser. In fact, if the automatic dispenser is able to contain several cartridges, identifying which product is in which location is essential. Identifying them by means of the chip is more reliable than entering the information manually during installation. The fact that the information relating to the product contained is stored in the cartridge itself enables the user to place the cartridges in any free location, the dispenser determining for itself the location of the various products.

In a third variant, as an alternative to or in combination with the first and/or the second variant, the chip advantageously stores usage history information for the cartridge that carries it.

In this case the automatic dispenser is programmed to read the usage history information stored in each chip, to adapt the actuation of the corresponding cartridge as a function of that information and to modify the usage history of the cartridge in each chip to take into account the possible actuation of the cartridge.

By adapting the operation it is understood that the system allows or does not allow the actuation of a cartridge as a function of the history information. For example, if the cartridge has already been activated in a given time period (for example a period of 24 hours), the system will prevent actuation of the cartridge.

The fact that the history information is stored in the cartridge itself prevents the user from bypassing the security system by placing the cartridge in question in another dispenser in the hope that the latter will deliver to them a dose of the product contained in that cartridge.

In a fourth variant in combination with the third variant, the chip preferably further stores maximum quantity of the product consumable per unit period information, for example maximum quantity of the product consumable each day information.

In this case the automatic dispensing system is programmed to read the information stored in the chip 140 of each cartridge, to consult the usage history information, to enable actuation of the corresponding cartridge if the maximum quantity of the product consumable per unit period has not been exceeded and to block actuation of the corresponding cartridge if the maximum quantity of product consumable per unit period has been exceeded.

The dispenser may advantageously be programmed to compare the prescribed quantity to the maximum quantity of the product consumable per unit period. This makes it possible to render dosing secure by guaranteeing that the programming of the automatic dispenser is always matched to the product contained in the cartridge.

The dispenser is preferably programmed to modify the history information in the chip to take into account the actuation of the cartridge.

Thus the quantity of product in each cartridge is updated on each use of the cartridge by the automatic dispenser and this makes it possible to ensure that the quantity of product usable is traced even in the case of use with a plurality of different machines.

This information may advantageously also be transmitted to the manufacturer or to the supplier via an internet-type communication network, which enables the delivery of a replacement cartridge to be triggered.

On each insertion of a cartridge into a machine the machine preferably interrogates a dedicated database to find out if that cartridge has already been used and what quantity of product remains in the cartridge.

The usage history of the machine combined with the maximum quantity of the product consumable each day makes it possible to render dosing secure by preventing too many dispensings from being effected in a given period, which could lead to the dispensing of a hazardous quantity of product. The fact of storing this information directly on the cartridges makes it possible to prevent bypassing this restriction by using the cartridges in another machine.

The electronic chip therefore enables backward checking and makes it possible to adapt the operation of the automatic dispenser dynamically.

In a fifth variant, as an alternative to or in combination with one or more of the previous variants, the chip stores information on the use by date of the cartridge.

In this case the dispenser is programmed to read the use by date information stored in each chip to enable actuation of the corresponding cartridge if the use by date of the cartridge has not been exceeded and to block actuation of the corresponding cartridge if the use by date of the cartridge has been exceeded.

This prevents the use of cartridges the product in which is no longer appropriate for consumption.

In a sixth variant, as an alternative to or in combination with one or more of the preceding variants, the chip is able to store batch number information. In this case the dispenser is programmed to read the batch number information stored in each chip, to compare it with information contained in the remote database, and to block actuation of the corresponding cartridge if the batch number corresponds to a manufacturing defect.

In a seventh variant, as an alternative to or in combination with one or more of the preceding variants, the chip is able to store quantity of product remaining in the cartridge information. In this case the dispenser is programmed to read the product quantity remaining in the cartridge information stored in each chip and to alert the user if the quantity of product remaining in a cartridge is less than a predetermined threshold quantity. That threshold quantity may be zero, in which case the dispenser alerts the use when the corresponding cartridge is empty. The threshold quantity is preferably greater than zero. It may be less than one dose, in which case the dispenser alerts the user when the corresponding cartridge is not able to deliver a complete dose. The threshold quantity may advantageously be greater than a few doses, in which case the dispenser alerts the user that it will soon be necessary to change the cartridge, which enables them to order another one in advance, with no risk of interruption of their treatment. Alternatively or additionally, the dispenser may include a connection to a remote information storage database via a communication network, the dispenser may be programmed to be connected to the remote database and, when the quantity of product remaining in a cartridge is less than the predetermined threshold quantity, automatically to trigger the ordering and the shipping of one or more cartridges before the corresponding cartridge or cartridges present in the dispenser are unusable (being empty or not containing sufficient product to dispense a dose). This is particularly useful if the user has a subscription, the subscription manager being able to manage the shipping of replacement cartridges as precisely as possible.

At least a portion of the memory of the chips is advantageously locked in write mode once it leaves the factory. This enables the chip to be protected against reprogramming by a third party. For example there may be stored in this locked part of the memory the maximum quantity of the product consumable each day, the unique identification number of the cartridge, the product contained, the expiry date of the product, the quantity of product remaining in the cartridge, the prescribed quantity to be dispensed of that product.

In the portion that is not locked against writing, there will advantageously be stored information that has to be updated and enables backward control in use: the history of usage of the cartridge, the quantity of product remaining in the cartridge and, advantageously, the prescribed quantity of the product to be dispensed that can be modified dynamically, for example by the health professional if it is a question of a food supplement.

FIG. 9 illustrates another embodiment in which actuation is effected in movement in translation parallel to the axial direction X-X of activation of the pump.

In this embodiment the shell includes one or more actuator ports 101a arranged in the axial direction of actuation relative to the pump. Thus in use this enables actuation of the pump by movement in translation of one or more activator rods 401 of the dispenser, parallel to the axial direction of X-X of actuation of the pump. In this case the actuator port or ports has/have no need to be in the form of a slot, but are cylindrical, of elliptical, circular or oval, or polygonal (square, rectangular, triangular, pentagonal, hexagonal, etc.) section.

What is important is that the section of the actuator port is less than a section of a finger of a three-year-old child, that is to say, according to the aforementioned Hodendorff study, less than 9 millimetres (which corresponds to the average size of the smallest phalange of the little finger), typically less than 6 millimetres maximum diameter for safety, to prevent manual actuation by a finger.

These ports must advantageously be distributed in a symmetrical manner to guarantee the correct orientation of the activation force.

In this embodiment, as illustrated in FIGS. 10 and 11, each actuator rod of the automatic dispenser is mounted to be mobile in translation parallel to the axial direction of actuation of the pump of the cartridges, each rod being intended to be inserted in an actuator port of a cartridge, the port being arranged in the axial direction relative to the pump.

In FIG. 10 the pump is activated by pressing directly on the pump through ports 101a carried by the closing part 130. In this case the pump is pressed down in translation relative to the reservoir that carries it and to the rigid shell, which enables the ejection of a dose of product.

In FIG. 11 the pump is activated by pressing indirectly on the pump. In fact, in this embodiment the actuator rods of the automatic dispenser press on the bottom of the reservoir 222 via ports 101a carried by the bottom 122 of the first housing portion 120 of the shell 100. The pump bearing against the closing portion 130 and the movement in translation of the reservoir 222 towards the closing part 130 relative to the pump and to the rigid shell leads to actuation of the pump.

The body, the top or the bottom of the reservoir are sufficiently rigid to enable direct or indirect transmission of the force applied by the activator rods 401 to the metering pump for the latter to eject a dose of product when the activation rods 401 bear on the top or the bottom of the reservoir.

In one advantageous embodiment of a shell in accordance with the invention the actuator ports (the slots in FIGS. 1 to 8 or the holes in FIGS. 9 to 11) may be reversibly blocked in the shell of the cartridge so that when the cartridge is in the automatic dispenser the latter deactivates the lock to open the ports and thus to allow the passage of the actuator rod or rods 400-401 carried by the automatic dispenser. To the contrary, when the cartridge is taken out of the automatic dispenser the lock is automatically activated and the actuator ports are blocked, preventing the passage of any rod.

In other words, the shell in accordance with the invention advantageously includes a passive access lock, that is to say that it blocks the actuator ports in the absence of action on the lock, and thus if the cartridge is outside the automatic dispenser, and frees the access to the actuator ports when the automatic dispenser is acting on the access lock. This makes it possible to prevent a user from attempting to actuate the pump outside the dispenser by inserting into the ports rigid rods such as paperclips or pins.

This embodiment is illustrated in FIGS. 13 to 19.

FIGS. 13 (seen from below) and 14 (seen from above) illustrate one embodiment of a lock of this kind for actuator holes arranged in the axial direction of actuation of the metering pump, that is to say corresponding to the embodiments from FIGS. 9 to 11.

In FIGS. 13 and 14 the access lock 500 includes blocking fins 501 arranged in a plane P1.

Under the plane P1 of the blocking fins 501 the lock includes spring tongues

502 intended to cooperate in abutment against stops 123 carried by the inner surface 124 of the shell (see FIG. 15).

To drive the lock between a locking position in which the activator holes are blocked by the fins 501 towards an unlocking position in which the activation holes are open, that is to say are no longer blocked by the ribs 501, the lock 500 includes a driving sleeve 504 having a polygonal imprint intended to receive an unlocking member (not shown) of complementary shape carried by and actuated by the automatic dispenser.

The shell 100 also includes an unlocking port 125 of identical shape to the imprint of the drive sleeve 504 for the unlocking member to be able to pass through the shell 100 and to mesh in the unlocking sleeve 504.

The leaf springs are arranged in such a manner as to be bent under force against the stops 123 during the movement of the blocking fins.

In the embodiment illustrated the leaf springs 502 are longer than the blocking fins 501 so that the latter are not blocked in rotation against the stops 123 that extend alongside the lock 500. Alternatively, in an embodiment not illustrated, the tongues 502 can be of identical length or of shorter length than the blocking fins 501 if the stops 123 extend under the plane P1 of the blocking fins. In this manner the blocking fins are able to move between the stops 123 and the bottom 122 of the shell 100.

For the lock illustrated the blocking fins 501 are moved in rotation to free up access via the actuator ports.

In accordance with the invention the leaf springs 502 are arranged relative to the blocking fins 501 so that the latter block the activation ports 101a in the locking position when the leaf springs 502 are not deformed elastically against the stops 123 and so that the blocking fins 501 do not block the activation ports 101a in the unlocking position when the leaf springs 502 are deformed elastically against the stops 123.

In other words, the relative arrangement of the leaf springs 502 and the blocking fins 501 ensure that in the unlocking position the leaf springs 502 are deformed elastically against the stops 123 and the blocking fins 501 do not obstruct the activator ports 101a. This unlocking position is obtained through the action of the unlocking member, which causes the lock to pivot forcibly, elastically deforming the leaf springs 502 against the stops 123.

To return to the locking position the unlocking member ceases to apply a force (here a torque) so that the lock returns of its own accord to the locking position thanks to the elastic return action of the leaf springs 502. Accordingly, in the locking position the leaf springs 502 are not deformed elastically against the stops 123 and the blocking fins 501 block the activation ports 101a.

FIGS. 16 and 17 illustrate the cartridge in the locking position, that is to say that the holes 101 are blocked by the blocking fins 501. In other words, this means the blocking fins 501, which can be seen via the actuator ports 101a. The leaf springs 502 are not deformed elastically against the stops 123.

To the contrary, FIGS. 18 and 19 illustrate the cartridge in the unlocking position, that is to say the holes 101a are open, that is to say are no longer blocked by the blocking fins 501. In other words, what can be seen through the actuator ports 101a is the reservoir 200. In this position the unlocking member has caused the lock to pivot forcibly against the return force exerted by the leaf springs 502 that are deformed (here they are curved like an arc) elastically against the stops 123.

The lock 500 in accordance with the invention is therefore passive because it blocks the access to the reservoir through actuator ports, in the absence of energy or of action.

Of course, the person skilled in the art could easily adapt this type of lock to the actuation slots of the embodiments from FIGS. 1 to 8, for example by arranging the various parts of the lock so as to enable movement in translation (and no longer in rotation) of the blocking fins.

The invention is not limited to the shape or to the structure of the drive sleeve described above and illustrated. What is important is that it enables the unlocking member to move the lock reversibly from the locking position to the unlocking position.

For example, the drive sleeve may comprise a drive sleeve itself made secure.

For example it may comprise at least one bolt mounted to slide relative to a striker element carried by the shell, the unlocking member including a magnet or an electromagnet able to move the bolt so as to be able to unlock the lock in rotation or in translation.

The invention not only allows dispensing of a fluid content with accurate metering by mechanical action of an automatic dispenser on the cartridge, but also excludes the possibility of using the product contained in the cartridge without the help of the dispenser (impossibility of recovering the content by a non-destructive manual action).

The invention also makes it possible to provide secure verification of the cartridge by the dispenser thanks to an electronic chip housing, ensuring correct usage and traceability of the cartridge.

It is thus possible to render dosing secure and to limit the use of the cartridge to a known dispensing quantity to prevent overuse of a potentially hazardous product.

1. An automatic dispenser of fluid products contained in cartridges, characterised in that it includes at least two fluid product cartridges each including a fluid product reservoir provided with a mechanical pump that can be actuated in an axial direction (X-X) and has a port (211) for ejection of product in a particular direction (F1), and a rigid protection shell (100) including a first outlet port (111) intended to be connected with the ejector port (211) of the pump (210), and at least one actuator port (101, 101a), the automatic dispenser further including at least two actuator rods (400. 401) that can be driven selectively in an axial direction (X-X) of activation of the mechanical pump of the cartridges, each actuator rod being intended to be inserted in the actuator port (101, 101a) of a cartridge to actuate the mechanical pump, the actuator ports (101, 101a) and the actuator rods (400, 401) having a section less than 9 millimetres, advantageously less than 6 millimetres, typically between 3 and 6 millimetres.

2. The automatic dispenser as claimed in claim 1, in which each actuator (400) is mounted to be mobile in pivoting and is intended to be inserted in the actuator port (101) of the shell and to be engaged in a yoke (201) carried by the reservoir of each cartridge to push the mechanical pump of the cartridge through the actuator port.

3. The automatic dispenser as claimed in claim 1, in which each actuator rod (401) is mounted to be mobile in translation parallel to the axial direction (X-X) of actuation of the pump of the cartridges, each actuator rod (401) being intended to be inserted in an actuator port (101a) of a cartridge, the port being arranged in the axial direction (X-X) relative to the pump.

4. The automatic dispenser as claimed in claim 1, in which the cartridges further include an electronic chip adapted to be read and/or written, the automatic dispenser including a system for reading/writing the electronic chip of each cartridge.

5. The automatic dispenser as claimed in claim 4, including a connection to a remote database storing information via a communication network, in which the chip stores at least one serial number of the cartridge, the dispenser being programmed to read the serial number in each chip, to be connected to the remote database to consult the stored information corresponding to the serial number of each cartridge, to adapt the actuation of the corresponding cartridge as a function of that information and to modify that information in the remote database to take into account actuation of the cartridge.

6. The automatic dispenser as claimed in claim 4, in which the chip stores information relating to the product contained in the cartridge, the dispenser being programmed to read the information stored in each chip, and to enable actuation of the corresponding cartridge if the product contained in the cartridge must be dispensed and to block actuation of the corresponding cartridge if the product contained in the cartridge must not be dispensed.

7. The automatic dispenser as claimed in claim 4, in which the chip stores cartridge usage history information, the dispenser being programmed to read the usage history information stored in each chip, to adapt the actuation of the corresponding cartridge as a function of that information and to modify the cartridge usage history in each chip to take into account actuation of the cartridge.

8. The automatic dispenser as claimed in claim 7, in which the chip additionally stores information as to the maximum quantity of the product that can be consumed per unit period, the dispenser being programmed to read the information stored in each chip, to consult the usage history information, to enable actuation of the corresponding cartridge if the maximum quantity of the product consumable per unit period is not exceeded and to block actuation of the corresponding cartridge if the maximum quantity of the product consumable per unit period is exceeded.

9. The automatic dispenser as claimed in claim 4, in which stores information as to the use by date of the cartridge, the dispenser being programmed to read the use by date information stored in each chip, to enable actuation of the corresponding cartridge if the use by date of the cartridge is not exceeded, and to block actuation of the corresponding cartridge if the use by date of the cartridge is exceeded.

10. The automatic dispenser as claimed in claim 4, in which the chip stores information as to the remaining quantity of product in the cartridge, the dispenser being programmed to read the remaining quantity of product in the cartridge information stored in each chip, to alert the user if the remaining quantity of product in a cartridge is less than a predetermined quantity threshold.

11. The automatic dispenser as claimed in claim 1, in which the cartridges include a shell provided with a passive access lock (500) mobile between a position blocking access to the actuator ports (101a) and a position unblocking access to said at least one actuator port (101a), the lock (500) including:
at least one fin (501) for blocking said at least one actuator port (101a),
at least one leaf spring (502) intended to be deformed elastically against at least one stop (123) carried by an interior surface (124) of the shell (100),
a drive sleeve (504) intended to receive an unlocking member to move said at least one blocking fin (501) from the locking position toward the unlocking position, said at least one leaf spring (502) being arranged relative to said at least one blocking fin (501) so that in the unlocking position the or each leaf spring (502) is deformed elastically against the or each stop (123) and said at least one blocking fin (501) does not block said at least one activator port (101a), and that in the locking position said at least one leaf spring (502) is not deformed elastically against said at least one stop (123) and said at least one blocking fin (501) blocks said at least one activator port (101a), the dispenser including an unlocking member adapted to cooperate with the drive sleeve (504) of the passive access lock (504) of each cartridge, the dispenser being programmed so that the unlocking member can reversibly move the passive access lock (504) of each cartridge from a locking position toward an unlocking position.)

12. A protection shell (100) for a reservoir (200) of fluid product provided with a mechanical pump (210) that can be activated in an axial direction (X-X) and has a port (211) for ejection of product in a particular direction (F1), characterised in that the shell (100) is rigid and includes a first outlet port (111) intended to be connected with the ejector port (211) of the pump (210) and at least one actuator port (101) adapted, in use, to cooperate with an actuator rod (400, 401) carried by an automatic dispenser as claimed in claim 1 to actuate the mechanical pump, the actuator port having a section less than 9 millimetres, advantageously less than 6 millimetres, typically between 3 and 6 millimetres.

13. The shell as claimed in claim 12, further including a housing (132) for an electronic chip (140) adapted to be read and/or written by a corresponding electronic system of the automatic dispenser, wherein cartridges of the automatic dispenser further include an electronic chip adapted to be read and/or written, the automatic dispenser including a system for reading/writing the electronic chip of each cartridge.

14. The shell as claimed in claim 13, in which the housing is arranged in the shell under a face of the shell perpendicular to the axial longitudinal direction (X-X).

15. The shell as claimed in claim 14, in which the housing is arranged in a centred manner relative to a median longitudinal axis (X-X) of the shell.

16. The shell as claimed in claim 12, further including a passive access lock (500) mobile between a position blocking access to the actuator ports (101a) and a position of unblocking access to said at least one actuator port (101a), the lock (500) including:
at least one fin (501) for blocking said at least one actuator port (101a),
at least one leaf spring (502) intended to be deformed elastically against at least one stop (123) carried by an interior surface (124) of the shell (100),
a drive sleeve (504) intended to receive an unlocking member to move said at least one blocking fin (501) from the locking position toward the unlocking position, said at least one leaf spring (502) being arranged relative to said at least one blocking fin (501) so that in the unlocking position the or each leaf spring (502) is deformed elastically against the or each stop (123) and said at least one blocking fin (501) does not block said at least one activator port (101a), and that in the locking position said at least one leaf spring (502) is not deformed elastically against said at least one stop (123) and said at least one blocking fin (501) blocks said at least one activator port (101a).

17. The shell as claimed in claim 12, in which the outlet port (111) is provided with a tube (112) connecting it to the ejector port (211) of the pump in the position of use.

18. The shell as claimed in claim 17, in which the connecting tube (112) has a shape such that in use the product is ejected via the outlet port in a direction (F4) different from the ejection direction (F1) of the ejector port (211) of the pump (210).

19. The shell as claimed in claim 12, in which the actuator port is a hole with a section less than 9 millimetres, advantageously less than 6 millimetres, typically between 3 and 6 millimetres.

20. The shell as claimed in claim 12, in which the actuator port is in the form a slot with a width less than 9 millimetres, advantageously less than 6 millimetres, typically between 3 and 6 millimetres.

21. The shell as claimed in claim 12, including a first or housing part (120) intended to receive a reservoir (200) of fluid product provided with a mechanical pump (210) that can be activated in an axial direction and a second or closing part (130) intended to be fixed to the first or housing part (120) when the reservoir (200) is inserted therein.

22. The shell as claimed in claim 12, including a stop assembly for inactivation of the pump.

23. The shell as claimed in claim 22, in which the stop assembly for inactivation of the pump includes a plane base (601) provided with at least one rigid locking rod (602) intended to bear against the reservoir (200) in the locking position, the plane base (601) further including a clipping portion (603) intended to be inserted in a port (102) of the shell (100), the shell (100) including on its front face (133) facing the pump (210) and perpendicular to the longitudinal axis (X-X) at least one port (103) intended to receive said at least one locking rod (602) and on a lateral face (104) parallel to the longitudinal axis (X-X), a port (102) for immobilising the clipping portion (603).

24. A fluid product cartridge for an automatic dispenser of fluid products contained in cartridges, the automatic dispenser characterised in that it includes at least two fluid product cartridges each including a fluid product reservoir provided with a mechanical pump that can be actuated in an axial direction (X-X) and has a port (211) for ejection of product in a particular direction (F1), and a rigid protection shell (100) including a first outlet port (111) intended to be connected with the ejector port (211) of the pump (210), and at least one actuator port (101, 101a), the automatic dispenser further including at least two actuator rods (400. 401) that can be driven selectively in an axial direction (X-X) of activation of the mechanical pump of the cartridges, each actuator rod being intended to be inserted in the actuator port (101, 101a) of a cartridge to actuate the mechanical pump, the actuator ports (101, 101a) and the actuator rods (400, 401) having a section less than 9 millimetres, advantageously less than 6 millimetres, typically between 3 and 6 millimetres, characterised in that it includes a shell as claimed in claim 12 and a fluid product reservoir provided with a mechanical pump that can be activated in an axial direction.

25. The fluid product cartridge as claimed in claim 24, wherein the automatic dispenser includes a system for reading/writing an electronic chip, the fluid product cartridge further including an electronic chip adapted to be read and/or written by a corresponding electronic system of the automatic dispenser.

26. The fluid product cartridge as claimed in claim 24, in which the reservoir is provided with at least one yoke (201) intended in use to receive an actuator rod driven by an automatic dispenser, the yoke being adapted to enable activation of the mechanical pump of the reservoir when the actuator rod is inserted in an actuator port of the shell and to move the yoke in the axial direction of actuation of the pump.

27. The cartridge as claimed in claim 26, in which the actuator port is in the form of a slot with a width less than the finger section of a three-year-old child and enables actuation of the pump by pivoting of the actuator rod in use.

28. The fluid product cartridge as claimed in claim 24, in which the actuator port of the rigid shell is arranged in the axial direction of actuation of the pump and is intended in use to receive an actuator rod driven in translation by the automatic dispenser to enable actuation of the pump by a movement in translation of the actuator rod (401) parallel to the axial direction of actuation of the pump.
